(19) United States
(12) Patent Application Publication
(10) Pub. No.: US 2010/0000744 A1
(43) Pub. Date: Jan. 7, 2010

(54) HIGH EXPANSION FOAM FIRE-EXTINGUISHING SYSTEM

(76) Inventor: Akihiko YOKOO, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/495,995

(22) Filed: Jul. 1, 2009

(30) Foreign Application Priority Data
Jul. 4, 2008 (JP) 2008-176248

(51) Int. Cl. A62C 35/00

(52) U.S. Cl. 169/15

(57) ABSTRACT

To obtain a desired foam expansion ratio even after aspiration of smoke, provided is a high expansion foam fire-extinguishing system, which discharges foam using a foam solution that has a dynamic surface tension γ of 25 mN/m or less, which is measured at a life time of 100 msec by a maximum bubble pressure method under a condition of a liquid temperature of 20° C.

### BACKGROUND OF THE INVENTION

1. Field of the Invention

The present invention relates to a high expansion foam fire-extinguishing system used in pits of oil tanks, culverts of oil industrial complexes, cabins, holds, or the like.

2. Description of the Related Art

As a fire-extinguishing system for buildings, generally, a sprinkler fire-extinguishing system is placed in most cases, and fire is extinguished by spraying water. In contrast, in oil tanks, cabins, or the like, a high expansion foam fire-extinguishing system is placed as a preparation to oil fire.

In the high expansion foam fire-extinguishing system, a foam solution is discharged from a emission nozzle and impinged on a foam forming screen to thereby suck air and generate foam, and the fire source is covered with such foam to extinguish the fire by cutting off oxygen supply. Further, the foam fire-extinguishing system in which a foam expansion ratio indicating a volume ratio of the foam solution and the generated foam is greater than or equal to 80 and smaller than 1,000 is referred to as a high expansion foam fire-extinguishing system.

Generally, in a foam solution used in a high expansion foam fire-extinguishing system, a foam fire-extinguishing agent made of a synthetic surfactant is mixed with water in an amount of about 3%.

Water itself is liquid with a large surface tension. However, when the foam fire-extinguishing agent is mixed with water to form a foam solution, the foam solution has a decreased surface tension and is likely to bubble.

Great amount of air needs to be taken in from an air suction port located at the upstream side of the emission nozzle in order to generate high expansion foam such as foam having the foam expansion ratio of greater than or equal to 500. In this case, a method of sucking air outside the room (referred to as “outside air”) is typically adopted when taking in great amount of air.

However, the method using outside air has problems such as increase in cost, because a hole needs to be formed and a duct needs to be formed in the hole to be passed through a building, or a hole needs to be formed in a separating wall to arrange a foam generating machine (foam generator) to use the air outside.

In order to solve such problems, a high expansion foam fire-extinguishing system of a method of sucking air within a emission section in which the foam is discharged (referred to as “inside air”) is used (see e.g., JP 06-165837 A).

In such a high expansion foam fire-extinguishing system of inside air, the foam expansion ratio significantly degrades compared to the high expansion foam fire-extinguishing system of outside air. The main factor thereof lies in the “smoke” generated in the room due to the occurrence of fire. Such smoke floats in the room as solid microparticles such as microparticles having a particle diameter of smaller than or equal to 1 μm. When being mixed with the air of the emission section and sucked by an air suction part, such microparticles are supplied to a foaming part together with air thereby degrading the foam expansion ratio.

### SUMMARY OF THE INVENTION

The present invention has been made in view of the above-mentioned circumstance, and an object of the present invention is therefore to obtain a desired foam expansion ratio even after aspiration of smoke.

According to the present invention, there is provided a high expansion foam fire-extinguishing system, which is characterized in that foam is discharged using a foam solution that has a dynamic surface tension of 25 mN/m or less, which is measured at a life time of 100 msec by a maximum bubble pressure method under a condition of a liquid temperature of 20° C.±1° C.

According to the present invention, there is provided a high expansion foam fire-extinguishing system, wherein the foam is discharged using a foam solution that has a dynamic surface tension of 18 mN/m to 23 mN/m, which is measured at the life time of 100 msec by the maximum bubble pressure method under the condition of the liquid temperature of 20° C.±1° C.

According to the present invention, there is provided a high expansion foam fire-extinguishing system, wherein the foam is discharged by mixing water with a foam fire-extinguishing agent to form a foam solution with a concentration of 2% or more so that the dynamic surface tension of the foam solution measured at the life time of 100 msec by the maximum bubble pressure method under the condition of the liquid temperature of 20° C.±1° C. is 18 mN/m to 24 mN/m.

The present invention uses the foam solution that has the dynamic surface tension of 25 mN/m or less, for example, 18 mN/m to 23 mN/m, which is measured at the life time of 100 msec by the maximum bubble pressure method under the condition of the liquid temperature of 20° C.±1° C. Therefore, a desired foam expansion ratio can be obtained even in a smoke environment.

### BRIEF DESCRIPTION OF THE DRAWINGS

In the accompanying drawings:

FIG. 1 is a graph of a first example of the present invention, showing a relationship between a dynamic surface tension and a life time;

FIG. 2 is a graph of the first example of the present invention, showing a relationship between a foam expansion ratio and a dynamic surface tension in smoke situation; and

FIG. 3 is a table of the first example of the present invention, showing samples, a dynamic surface tension, a foam expansion ratio, and the like.

### DETAILED DESCRIPTION OF THE PREFERRED EMBODIMENTS

The inventors of the present invention found that smoke particles should be removed in order to solve the above-mentioned problem. However, the inventors considered that it may be possible to prevent the decrease in foam expansion ratio even without removing smoke particles.

Based on the study conducted so far, the inventors presumed that the phenomenon of the decrease in foam expansion ratio by smoke is ascribed to the reaction between surfactant molecules and smoke particles on the surface of a foam film. That is, when smoke is aspirated during foaming, the density of the surfactant molecules on the surface of the foam film decreases due to the reaction with the smoke particles. Then, the inventors presumed that the phenomenon of the remarkable decrease in foam expansion ratio occurs.

Conventionally, in a high expansion foam fire-extinguishing system, a foam fire-extinguishing agent made of a synthetic surfactant is used under the condition of being diluted to an aqueous solution in a concentration of about 3%. The static (in equilibrium) surface tension of these foam solutions is about 22 mN/m. However, in a dynamic state of “foaming” in which foam is injected from a nozzle in the form of liquid droplets to form a film on a foaming net, the surface shape and surface area of the foam solution change rapidly in a short period of time.

Therefore, as the surface age to be a time for forming a foam becomes shorter, the adsorption of surfactant molecules to the surface of a foam film cannot catch up with the surface age, and the surface tension in the dynamic state increases. For example, when the above-mentioned dynamic surface tension of a foam solution is measured by the maximum bubble pressure method, the dynamic surface tension is 30 mN/m or more at a bubble life time of 100 msec.

Note that, herein, the “surface age” refers to a time required for forming an interface between an aqueous solution and air such as foam, the “surface age” corresponding to the “life time” according to the maximum bubble pressure method.

As the value of the dynamic surface tension increases, the density of the surfactant on the surface of the foam film decreases. On the other hand, during foaming, in the case of aspirating smoke, the density of surfactant molecules on the surface of the foam film further decreases due to the reaction with smoke molecules, which remarkably decreases a foam expansion ratio.

Thus, the inventors considered that it is effective to increase the density of the surfactant on the surface during foam film formation in order to enhance the durability with respect to smoke to suppress the decrease in foam expansion ratio. The density of the surfactant on the surface during foam film formation is reflected to the value of the dynamic surface tension, and the density of the surfactant on the surface increases as the dynamic surface tension decreases, as described later.

Based on such considerations, the inventors found from various experiments that a desired foam expansion ratio is obtained even after aspiration of smoke by adjusting the dynamic surface tension of a foam solution in a predetermined range. Hereinafter, this finding is described in detail.

First, the “method of measuring a dynamic surface tension by a maximum bubble pressure method” is described.

The method of measuring a dynamic surface tension includes various methods such as the maximum bubble pressure method (which may also be referred to as a “bubble pressure method”) and a dropping capacitance method. As a result of studying the adaptable time range, the reproducibility, and the like, the inventors found that the above-mentioned “maximum bubble pressure method” is optimum for the measurement of the dynamic surface tension of a foam solution, and hence the inventors decided to adopt this measurement method.

Hereinafter, the maximum bubble pressure method is described.

Bubbles are extruded with compressed air from the tip end of a thin tube called probe inserted in a foam solution. This method is like a method of bubbling by putting a straw into water in a cup. A pressure sensor is provided at the base of the probe, and changes in an internal pressure in the probe are detected by the pressure sensor along with the generation of bubbles.

The pressure in the probe increases along with the generation of the bubbles. When the initial internal pressure is defined as P0, and the maximum internal pressure is defined as Pmax, a surface tension γ of the foam solution is represented by the following formula according to the Young-Laplace equation. Herein, r represents a radius of a probe hole.

γ=(Pmax−P0)r/2

Thus, the method of calculating the surface tension from a change in a pressure involved in the generation of bubbles is the “maximum bubble pressure method”. According to this equation, as the dynamic surface tension is smaller, bubbles are generated at a smaller pressure.

The period of time from a time when the bubbles start being generated (P0) to a time when the internal pressure becomes maximum (Pmax) is referred to as a “life time”. By changing this life time, the surface tension in various time zones can be measured.

As a dynamic surface tension meter according to the maximum bubble pressure method, “BP-D5” (Tradename, manufactured by Kyowa Interface Science Co., Ltd.), and SITAt60 (Tradename, manufactured by EKO INSTRUMENTS CO., LTD.) were used.

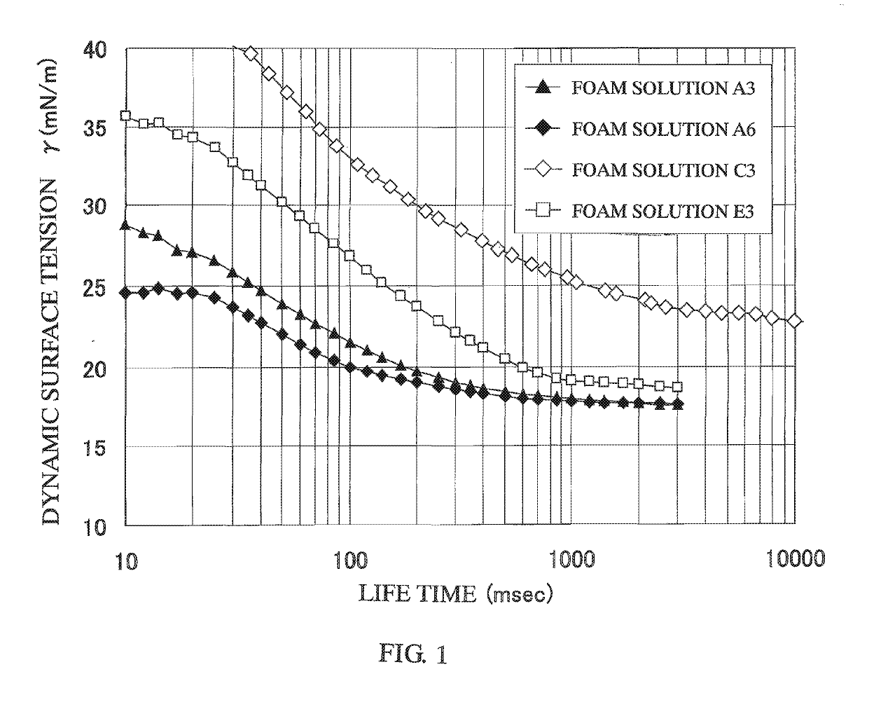

The “relationship between the dynamic surface tension and the life time” of the foam solution measured by the maximum bubble pressure method is described with reference to FIG. 1.

This graph is obtained by plotting the dynamic surface tension γ (mN/m) measured by changing the life time of bubbles from 10 msec to 10000 msec (10 seconds) using the following samples (No. 1 to No. 4) at a liquid temperature of 20° C. Generally, when the temperature rises, the molecular movement of a liquid becomes active, and hence the surface tension thereof decrease. Thus, it is necessary to manage the liquid temperature of the samples in measurement of the dynamic surface tension, and the dynamic surface tension was measured at 20° C.±1° C. in the present invention.

No. 1 foam solution A3: a foam fire-extinguishing agent A containing a fluorine-based surfactant as a main component. The foam fire-extinguishing agent A is used in a mixed ratio with water (i.e., 3% concentration). The “concentration” represents the mixed ratio with water in the following agents.

No. 2 foam solution A6: the foam fire-extinguishing agent A containing the fluorine-based surfactant as a main component is used in a concentration of 6%.

No. 3 foam solution C3: a synthetic surfactant foam fire-extinguishing agent C containing a hydrocarbon-based surfactant as a main component used in a high expansion foam fire-extinguishing system is used in a standard concentration of 3%.

No. 4 foam solution E3: an aqueous film forming foam agent E containing a fluorine-based surfactant as a main component used in a low expansion foam fire-extinguishing system is used in a standard concentration of 3%.

The measurement results are as shown in FIG. 1 (graph). In this graph, a vertical axis represents a dynamic surface tension γ (mN/m) and a horizontal axis represents a life time (msec).

As is understood from the graph, the dynamic surface tension γ (mN/m) of each sample increases as the life time is shorter and decreases gradually as the life time is longer. Herein, the surface tension in the case where the life time is extended infinitely corresponds to a so-called (static (in equilibrium) surface tension). Then, the static surface tension at a liquid temperature of 20° C. of each measured sample was about 16 mN/m for the foam solutions A3, A6, and E3, and 22 mN/m for the foam solution C3.

In the graph of FIG. 1, when the foam solution A3 and the foam solution A6 are compared with each other, they are overlapped and the difference therebetween is not seen at a life time of 1000 msec or more. On the other hand, as the life time was became shorter at 1000 msec or less, the greater the difference therebetween was clearly seen, and the surface tension of the foam solution A3 was about 22 mN/m at 100 msec and that of the foam solution A6 was about 20 mN/m. That is, the foam agent has a smaller dynamic surface tension when the concentration is higher. Such a difference is considered to be ascribed to the content of the surfactant.

Further, the dynamic surface tensions of the fluorine-based surfactants A and E are smaller than that of the hydrocarbon-based surfactant C even at the same foam agent concentration. For example, the dynamic surface tension of the foam agent C3 at a life time of 100 msec is 33 mN/m, the dynamic surface tension of the foam agent E3 is 27 mN/m, and that of the foam agent A3 is 22 mN/m. Such a difference is considered to be ascribed to the kind of the surfactant contained in the foam agent.

The surface tension at a life time of 30 msec or less may not be measured depending upon a commercially available dynamic surface tension meter. Therefore, for comparing the dynamic surface tension characteristics of the foam solution, it is effective to use a value measured at a life time of about 100 msec.

Next, the “relationship between the dynamic surface tension and the foam expansion ratio in smoke situation” is described.

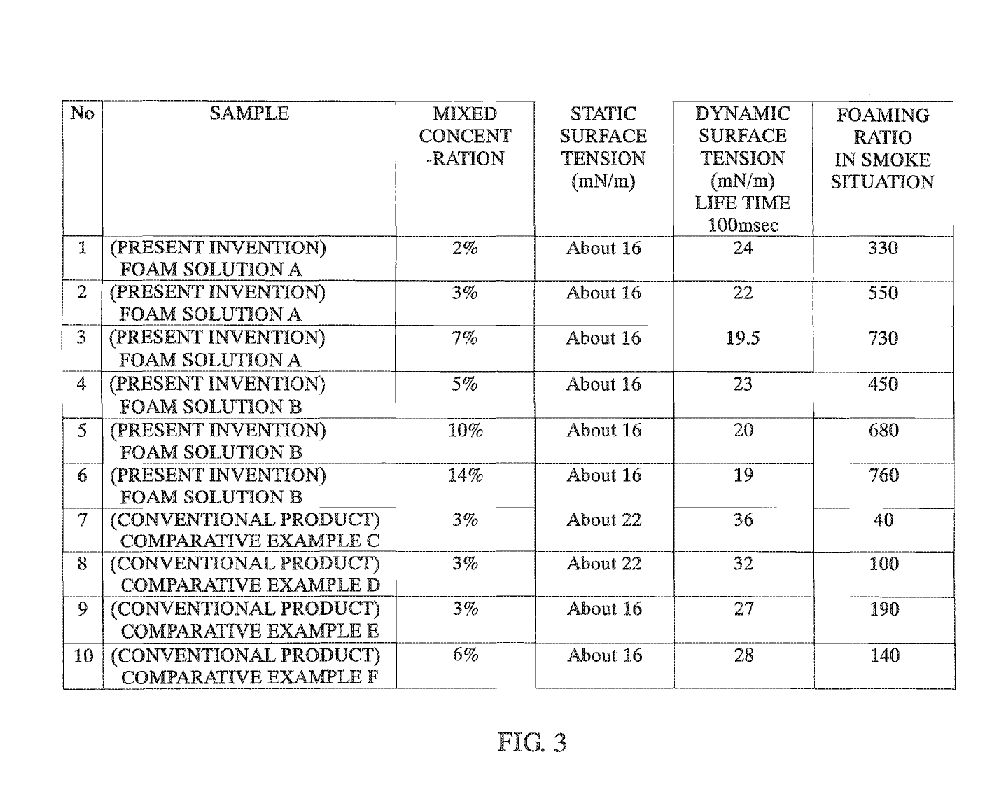

In order to find out the relationship therebetween, the measurement of the dynamic surface tension γ (mN/m) at a life time of 100 msec and the measurement of the foam expansion ratio in smoke situation were conducted using the samples (No. 1 to No. 10) in FIG. 3.

No. 1-3 (present invention) foam solution A: a foam fire-extinguishing agent A containing a fluorine-based surfactant as a main component was used in concentrations of 2, 3, and 7%.

No. 4-6 (present invention) foam solution B: an aqueous film forming foam agent B containing a fluorine-based surfactant as a main component used in a low expansion foam fire-extinguishing system was used in concentrations of 5, 10, and 14%.

No. 7 (conventional product) foam solution C: a synthetic surfactant foam fire-extinguishing agent C used in a high expansion foam fire-extinguishing system was used in the standard concentration of 3% (main component is a hydrocarbon-based surfactant).

No. 8 (conventional product) foam solution D: a synthetic surfactant foam fire-extinguishing agent D used in a high expansion foam fire-extinguishing system was used in the standard concentration of 3% (main component is a hydrocarbon-based surfactant).

No. 9 (conventional product) foam solution E: an aqueous film forming foam agent E used in a low expansion foam fire-extinguishing system was used in the standard concentration of 3% (main component is a fluorine-based surfactant).

No. 10 (conventional product) foam solution F: an aqueous film forming foam agent F used in a low expansion foam fire-extinguishing system was used at 6% that is twice the standard concentration (main component is a fluorine-based surfactant).

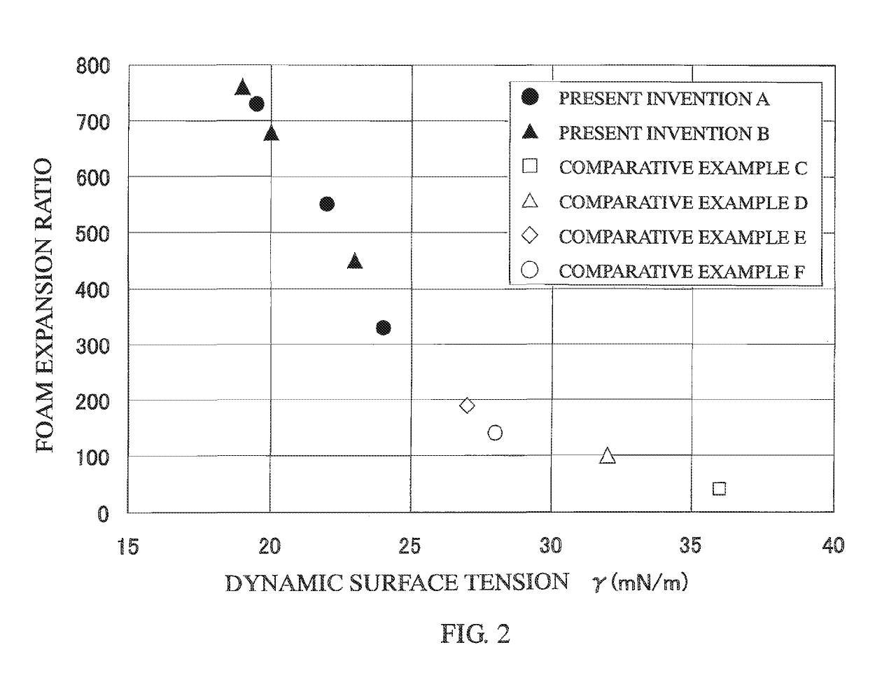

The measurement results are as shown in FIG. 2 (graph) and FIG. 3 (Table). In FIG. 2, a vertical axis represents a foam expansion ratio in smoke situation, and a horizontal axis represents a dynamic surface tension γ (mN/m) at a life time of 100 msec. Note that the foam expansion ratio in smoke situation is measured at a smoke concentration of obscuration ratio of 15%/m by smoking a rubber tire. Further, the dynamic surface tension γ is measured at a liquid temperature of 20° C. of a sample.

As is understood from FIG. 2, as the dynamic surface tension γ at a life time of 100 msec is smaller, the foam expansion ratio in smoke situation is higher. For practical use as a high expansion foam fire-extinguishing system, the foam expansion ratio should be 300 times or more. Therefore, it is understood from the graph that the dynamic surface tension of a foam solution should be 25 mN/m or less.

Further, as is understood from Samples Nos. 1 to 3 and Nos. 4 to 6 in FIG. 3, as the foam agent concentration is higher, the foam expansion ratio is higher.

In any of the foam solutions C, D, E, and F of the conventional products as the comparative examples, the dynamic surface tension at a life time of 100 msec is 27 mN/m or more. Then, the foam expansion ratio in smoke situation is 200 times or less, which is not suitable for practical use.

On the other hand, in any of the foam solutions A and B of the present invention, the dynamic surface tension at a life time of 100 msec is 25 mN/m or less, and the foam expansion ratio in smoke situation is 300 times or more, which is suitable for practical use as a high expansion foam fire-extinguishing system.

From the above, it is preferred that the foam solution of the present invention to be used in a high expansion foam fire-extinguishing system has a dynamic surface tension of 25 mN/m or less at a life time of 100 msec measured at a liquid temperature of 20° C.

Further, it is more preferred to set the dynamic surface tension to be 23 mN/m or less because the foam expansion ratio in smoke situation is 400 time or more. The foam solution of the present invention to be used in a high expansion foam fire-extinguishing system is not particularly limited, because the foam expansion ratio is enhanced as the dynamic surface tension at a life time of 100 msec is smaller. However, increase of the foam expansion ratio is saturated when the dynamic surface tension is 18 mN/m or less, and hence it is preferred to set the lower limit value to be 18 mN/m practically. The lower limit value may be a value taken by a static surface tension.

The foam fire-extinguishing agent A prepared as a foam fire-extinguishing agent of the present invention to be used in a high expansion foam fire-extinguishing system has a dynamic surface tension of 24 mN/m or less at a life time of 100 msec measured at a liquid temperature of 20° C. in the case where the mixed concentration with water is 2% (FIG. 3, Sample No. 1).

Thus, for the high expansion foam fire-extinguishing system, it is preferred to use a foam solution in which the foam fire-extinguishing agent of the present invention is mixed in a concentration of 2% or more, whereby the foam expansion ratio of 300 times or more can be obtained even in smoke situation.

It is preferred that, as the foam solution of the present invention to be used in a high expansion foam fire-extinguishing system, there is used a foam fire-extinguishing agent such as a fluorine-based surfactant containing a surfactant whose static surface tension at a concentration equal to or more than a micelle critical concentration becomes small.

The conventional foam fire-extinguishing agent used in a high expansion foam fire-extinguishing system is a “synthetic surfactant foam fire-extinguishing agent” containing a hydrocarbon-based surfactant as a main component based on standards of fire equipment inspection. The static surface tension in this agent is about 22 mN/m as in the above-mentioned example.

In contrast, an “aqueous film forming foam agent” based on standards of fire equipment inspection contains a fluorine-based surfactant as a main component, and is considered to have a micelle critical concentration at which the static surface tension is saturated at a lower limit value generally in a mixed concentration of 0.5% or less, with the result that the value thereof is about 16 to 17 mN/m. As is understood from the foam solutions C3 and E3 in FIG. 1 (graph), the dynamic surface tension also tends to become relatively small when the static surface tension value is smaller. Thus, an agent containing a fluorine-based surfactant as in the above-mentioned “aqueous film forming foam agent” is suitable as a foam fire-extinguishing agent used in a foam solution used in a smoke situation.

As described above, it is understood that it is necessary to decrease the dynamic surface tension in order to enhance the foaming performance in the presence of smoke, and as the method therefor, the following can be said based on the features of the dynamic surface tension of a foam solution. That is, regarding the foam fire-extinguishing agent, “the main component of a foam fire-extinguishing agent should be an aqueous film fluorine-based surfactant”, and “the concentration of a surfactant should be high”.

Herein, as a result of investigating the dynamic surface tension of the conventional aqueous film forming foam agents (foam solutions E, F) containing a fluorine-based surfactant, any agent has a dynamic surface tension of 25 mN/m or more at a life time of 100 msec measured at a liquid temperature of 20° C. at a standard use concentration, which is not suitable for use in a high expansion foam fire-extinguishing system in a smoke situation. However, it was found that the dynamic surface tension at a life time of 100 msec can be set to be 25 mN/m or less by adjusting the concentration to be higher than the standard use concentration.

The foam fire-extinguishing agent B of the present invention has been used conventionally in a standard concentration of 3% as an aqueous film forming foam agent for a low expansion foam fire-extinguishing system. It was found from the measurement results that, when the mixed concentration thereof is set to be 4% or more, the dynamic surface tension at a life time of 100 msec is 25 mN/m or less. In the present invention, by using the foam fire-extinguishing agent B in a concentration of 5% or more, the foam expansion ratio of 400 times or more in smoke situation can be obtained.

However, a high foam expansion ratio under a smoke situation is not always obtained by setting the concentration to be higher than the standard use concentration in any aqueous film forming foam agent. For example, as in the conventional product F in FIG. 3 described above, even if the concentration is set to be 6% which is twice the standard use concentration, the dynamic surface tension at a life time of 100 msec is about 28 mN/m, and the foam expansion ratio in smoke situation does not reach 200 times.

In the case of using the foam fire-extinguishing agent F, it is necessary to set the concentration to be 10% or more in order to set the dynamic surface tension at a life time of 100 msec to be 25 mN/m or less. However, in this case, the cost for the equipment involved in the storage and mixing of foam fire-extinguishing agent increases, which is not suitable as fire-fighting equipment.

Further, though the foam expansion ratio can be increased by increasing the concentration of a foam agent, the foam expansion ratio is saturated even if the concentration is increased. Therefore, increasing the concentration more than necessary increases a fluorine-based surfactant to be added, which increases an agent cost. Thus, by decreasing the dynamic surface tension, it is possible to increase the foam expansion ratio. Considering the saturation of the foam expansion ratio, the appropriate value of the lower limit of the dynamic surface tension γ is about 18 mN/m.

What is claimed is:

1. A high expansion foam fire-extinguishing system characterized in that foam is discharged using a foam solution that has a dynamic surface tension of 25 mN/m or less, which is measured at a life time of 100 msec by a maximum bubble pressure method under a condition of a liquid temperature of 20° C.±1° C.

2. A high expansion foam fire-extinguishing system according to claim 1, wherein the foam is discharged using a foam solution that has a dynamic surface tension of 18 mN/m to 23 mN/m, which is measured at the life time of 100 msec by the maximum bubble pressure method under the condition of the liquid temperature of 20° C.±1° C.

3. A high expansion foam fire-extinguishing system according to claim 1, wherein the foam is discharged by mixing water with a foam fire-extinguishing agent to form a foam solution with a concentration of 2% or more so that the dynamic surface tension of the foam solution measured at the life time of 100 msec by the maximum bubble pressure method under the condition of the liquid temperature of 20° C.±1° C. is 18 mN/m to 24 mN/m.
